(19) United States
(12) Patent Application Publication
(10) Pub. No.: US 2002/0042728 A1
(43) Pub. Date: Apr. 11, 2002

(54) Method for charging for services provided to manufacturing companies

(76) Inventor: Oded Berkooz, Holon (IL)

Correspondence Address: BROWN PINNISI & MICHAELS, 400 M & T BANK BUILDING, 118 NORTH TIOGA ST, ITHACA, NY, 14850

(21) Appl. No.: 09/972,307

(22) Filed: Oct. 5, 2001

Related U.S. Application Data
(60) Provisional application No. 60/239,033, filed on Oct. 10, 2000.

(51) Int. Cl. G06F 17/60

(52) U.S. Cl. 705/4

(57) ABSTRACT

A method for charging for services provided to manufacturing companies is disclosed. Manufacturing areas where the production of proper products depends on the manufacturing equipment being set up appropriately are particularly targeted. The present method preferably includes a provider and a manufacturer such that the provider eliminates the risk of variable costs associated with setting up the manufacturer's manufacturing machines. The provider provides the manufacturer with a procedure to use when setting up a manufacturing process. The provider also provides a guarantee to the manufacturer. The guarantee preferably states that if the manufacturer follows the procedure, the manufacturing process will require less than a prescribed number of tests to get the target metrics of the product into an acceptable range. If the manufacturing process requires more than the prescribed number of tests, then the provider is required to pay the manufacturer a first agreed upon sum. In exchange for the guarantee, the manufacturer agrees to pay the provider a second agreed upon sum.

### BACKGROUND OF THE INVENTION

1. Field of the Invention

The invention pertains to the field of methods for business arrangements. More particularly, the invention pertains to methods for establishing business relationships between manufacturers and those entities that provide services to the manufacturers.

2. Description of Related Art

One view on the state of the art comes from the field of insurance and actuarial practices. In certain manufacturing industries, a manufacturer can buy insurance that will cover the operation of their plants so long as they maintain the equipment according to prescribed standards. This practice can be found for instance in the insurance of steam boilers. This practice is materially different than the disclosed innovation because it does not involve any measure relating to the quality of product produced or effectiveness of the equipment. Assurance of availability of equipment provides no value to the manufacturer that seeks to control the risks associated with variability in manufacturing. Furthermore, the disclosed innovation is useful only when the equipment is operational, hence the existing practice of insuring equipment availability complements the disclosed innovation.

Another view on the state of the art comes from the field of engineering software and services. Often a manufacturing company that seeks to improve the economics of its manufacturing operations will buy software or seek a consultant or service provider that will give them a procedure to follow when setting up their manufacturing equipment. The vendor is then compensated for their time and materials, or their intellectual property is licensed. However, the state of the art today does not include any element of guarantee that carries a payment from the vendor to the manufacturer in case the setup proposed by the vendor does not perform as agreed to in a contract.

### SUMMARY OF THE INVENTION

A method for charging for services provided to manufacturing companies is disclosed. Manufacturing areas where the production of proper products depends on the manufacturing equipment being set up appropriately are particularly targeted. The present method preferably includes a provider and a manufacturer such that the provider eliminates the risk of variable costs associated with setting up the manufacturer's manufacturing machines. The provider provides the manufacturer with a procedure to use when setting up a manufacturing process. The provider also provides a guarantee to the manufacturer. The guarantee preferably states that if the manufacturer follows the procedure, the manufacturing process will require less than a prescribed number of tests to get the target metrics of the product into an acceptable range. If the manufacturing process requires more than the prescribed number of tests, then the provider is required to pay the manufacturer a first agreed upon sum. In exchange for the guarantee, the manufacturer agrees to pay the provider a second agreed upon sum.

It is typical in such applications that either a trial-and-error process is undertaken to bring the equipment to proper operating conditions, or more systematic methods that attempt to model the behavior of the equipment and use the model to assist in getting the equipment to proper operating conditions. Today, the operator of such equipment is exposed to variable costs of setup that depend on how long it takes to get a manufacturing machine to proper operating conditions.

### BRIEF DESCRIPTION OF THE DRAWINGS

FIG. 1 shows a flowchart of the general method in an embodiment of the present invention.

FIG. 2a shows a flowchart of the initial steps in an embodiment of the present invention.

FIG. 2b shows a flowchart continuing the method of FIG. 2a in an embodiment of the present invention.

FIG. 2c shows a flowchart continuing the method of FIG. 2b in an embodiment of the present invention.

### DETAILED DESCRIPTION OF THE INVENTION

A method of operating a business arrangement is disclosed. In its simplest embodiment, the arrangement is made between two parties: a manufacturer (MANUFACTURER) that is interested in reducing his financial risk associated with fluctuating manufacturing costs resulting from fluctuations in the number of tests required, and a service provider (PROVIDER) that undertakes a set of commitments described below.

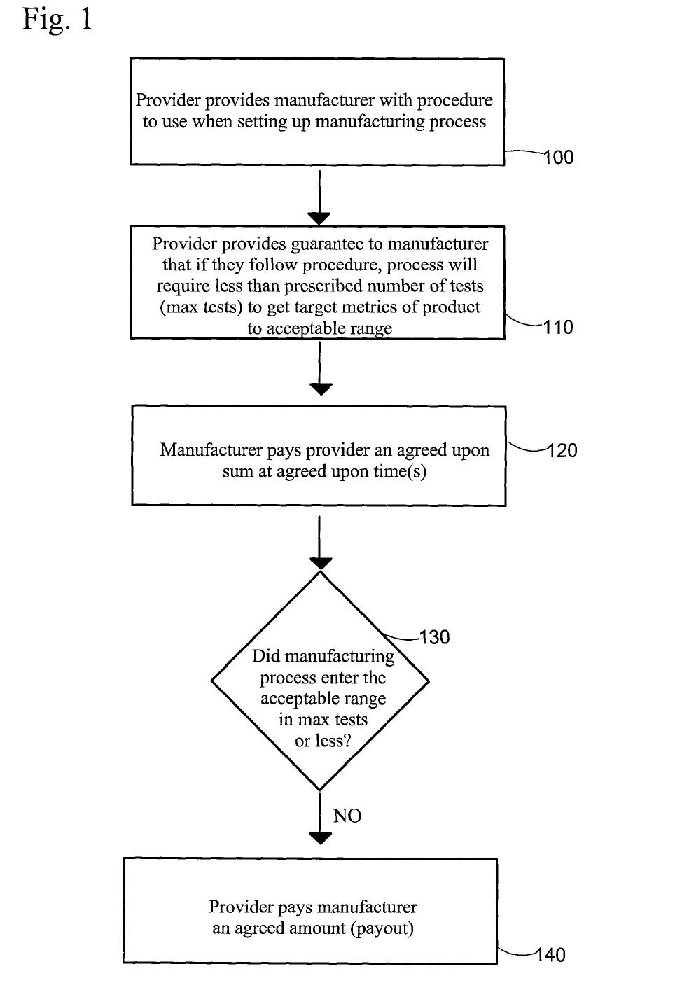

Referring to FIG. 1, a sample embodiment of the agreement between the two parties is as follows:

In step (100), the PROVIDER provides to the MANUFACTURER a procedure (PROCEDURE) to use when setting up a manufacturing process. The nature of the PROCEDURE is such that is suggests to the MANUFACTURER what tests to perform in order to get the target metrics into the acceptable range.

The PROVIDER is committed to providing a PROCEDURE to the MANUFACTURER. This commitment may include any of the following components, alone or in combination. The PROVIDER may provide software that suggests to the MANUFACTURER what tests to perform based on inputs provided by the MANUFACTURER to the software. The software may be provided as a standalone item or as software that interfaces with automatic manufacturing control and/or execution systems. The software may make use of a communications network to transmit the information to and from remote computers. The PROVIDER also may provide procedures for qualifying the manufacturing process, materials, manufacturing machine, and measurement equipment. In addition, the PROVIDER may provide training to the personnel of the MANUFACTURER. The training may include qualification of operators. The PROVIDER may also provide support and upgrades on an agreed upon basis. The PROVIDER also agrees to hold information provided by the MANUFACTURER in confidence.

In step (110), the PROVIDER provides a guarantee (GUARANTEE) to the MANUFACTURER that, if the MANUFACTURER follows the PROCEDURE, the manufacturing process will require less than a prescribed number of tests to get the target metrics of the product to the acceptable range (MAX TESTS).

The GUARANTEE may include any of the following components, alone or in combination. First, the PROVIDER may guarantee that after maintenance or clean up the equipment will get to an operational point in less than a prescribed number of tests. Also, the PROVIDER may guarantee that every time a test is performed as part of the routine procedure and the results of the test and desired goals are input to the PROCEDURE, the proposed setup will bring the performance metrics of the resultant product to the acceptable range. The GUARANTEE may also include that the setup resulting from the application of the PROCEDURE will have the lowest sensitivities as measured by a software tool provided by the PROVIDER. Sensitivities indicate the extent to which a metric that one wishes to control depends on a setup parameter. A “high” sensitivity indicates that relatively small changes in a setup parameter result in large changes in the metric, while a setup with a “low” sensitivity requires large changes in a setup parameter to change the metric. Sensitivities are preferably expressed as numbers, graphs or tables. The PROVIDER may also guarantee that, on average, the number of tests performed will be less than a prescribed amount.

In consideration of the PROCEDURE, the GUARANTEE, and the potential future PAY OUT, the MANUFACTURER pays the PROVIDER an amount that may depend on the manufacturing process, product and material in step (120). The fee is preferably calculated by any of the following methods, alone or in combination: a fixed amount per prescribed period of time per piece of manufacturing equipment, a fixed amount per use of the PROCEDURE, a fixed sum per manufacturing facility, or charges for support of the MANUFACTURER in the application of the PROCEDURE.

In step (130), the question whether the manufacturing process entered the acceptable range in MAX TESTS or less is asked. Every time the MANUFACTURER follows the PROCEDURE and the manufacturing process does not enter the acceptable range in MAX TESTS, or less, experiments, the PROVIDER pays the MANUFACTURER an agreed amount (PAY OUT) that can be fixed or variable in step (140). However, if the manufacturing process does enter the acceptable range in less than or equal to MAX TESTS, the PROVIDER is not required to pay the MANUFACTURER anything.

The agreement includes a commitment by the PROVIDER to reimburse the MANUFACTURER when the PROCEDURE provided by the PROVIDER does not enter the acceptable range in MAX TESTS or less. This commitment may be subject to exclusions that include the following, alone or in combination. First, all the qualifications agreed upon between the PROVIDER and the MANUFACTURER must have been performed. The MANUFACTURER will notify the PROVIDER within a given period of time that the PROCEDURE did not produce the committed to results and will allow the PROVIDER a prescribed amount of time to improve the PROCEDURE. The MANUFACTURER will not seek reimbursement from the PROVIDER for setups performed prior to the time the PROVIDER agrees to resumption of the use of the PROCEDURE.

The reimbursement to the MANUFACTURER described above is preferably calculated by either of the following methods alone or in combination. First, reimbursement may be determined based on the down time of the manufacturing process. Alternatively, reimbursement is determined on a fixed price per failure of the PROCEDURE. In a third method, reimbursement is based on a modified price per each failure of the PROCEDURE as in an agreed upon formula.

Variations to the preferred embodiment preferably include, but are not limited to, guarantees concerning requirements for training of operators, proper performance of the equipment, qualification of various auxiliary equipment used to measure the target metrics and, as well as other variations.

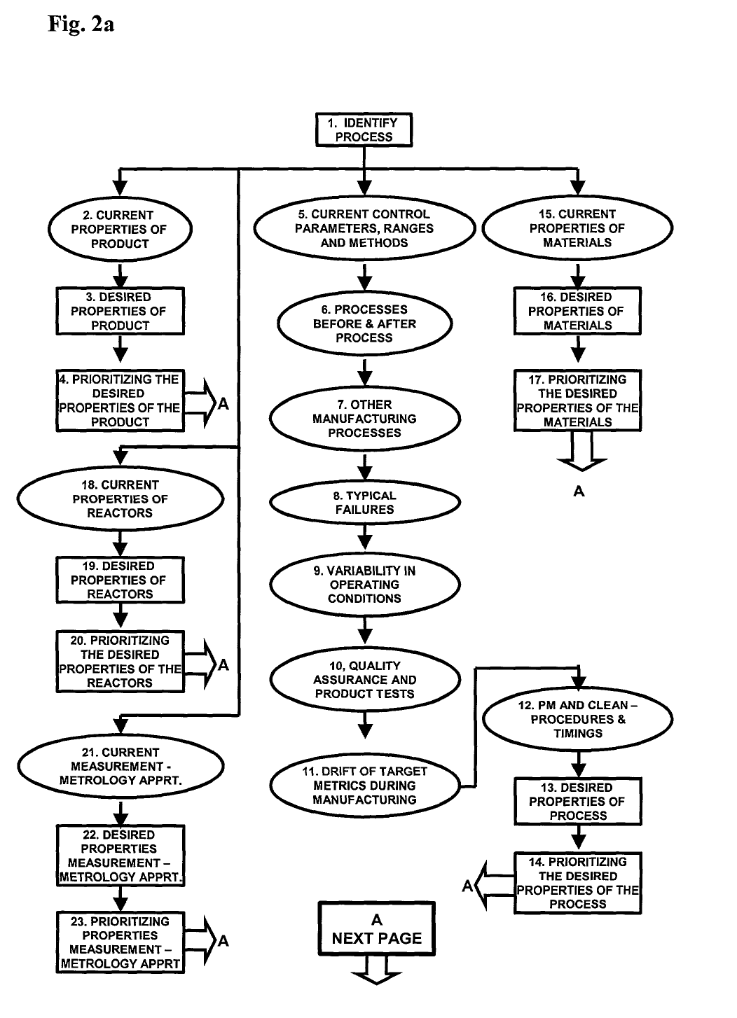

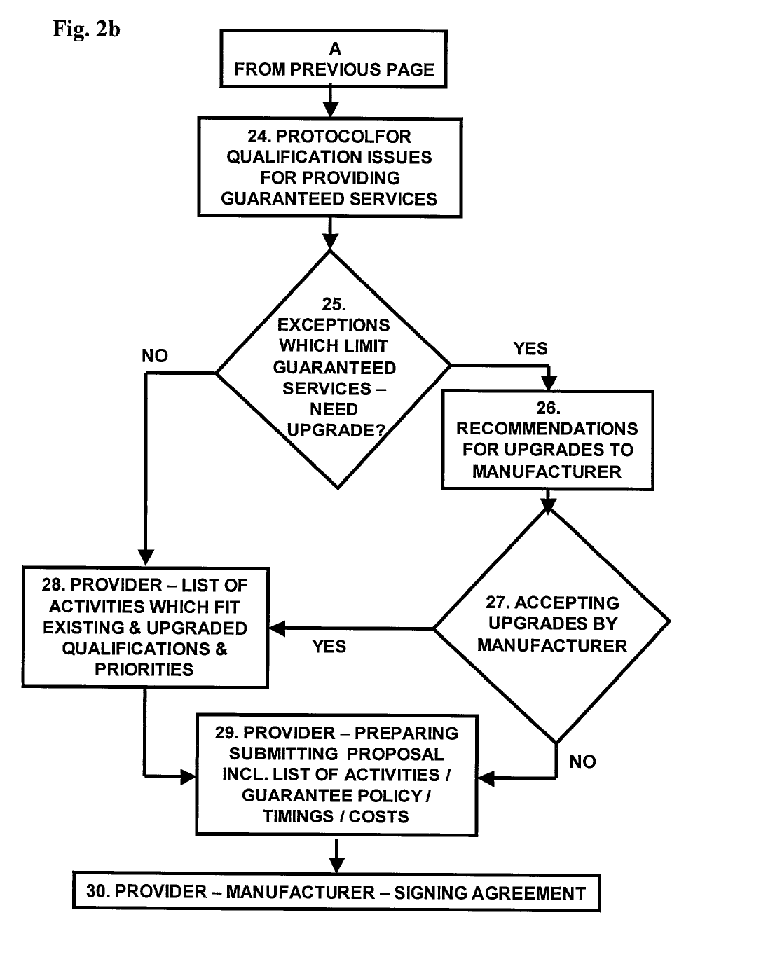

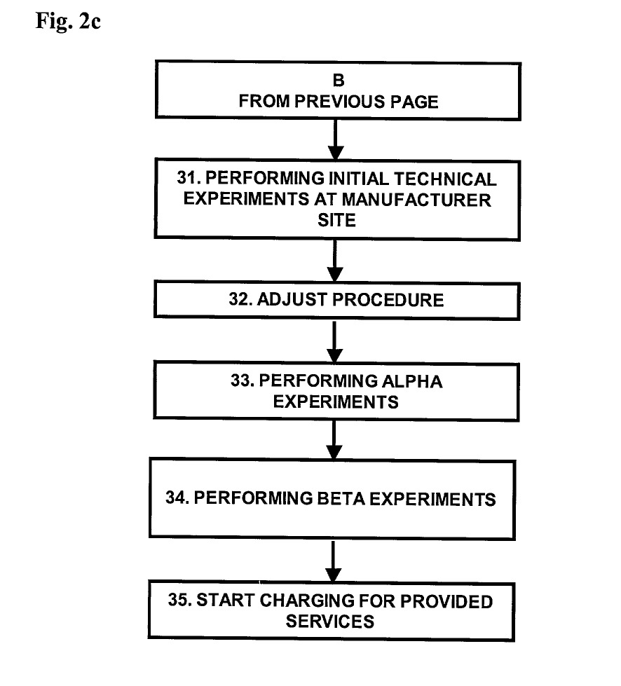

Referring also to FIG. 2a through 2c, to consummate the agreement between the MANUFACTURER and the PROVIDER, a method which includes the following steps, or any subset of them, is preferably undertaken:

1. Identify the manufacturing process: The MANUFACTURER identifies to the PROVIDER the manufacturing process for which it would like to have a guarantee. During this step, the manufacturing machines on which the identified process is being performed are also identified.

2. Characterize the current properties of product: The PROVIDER and/or the MANUFACTURER collect information that characterizes the properties of products as they are manufactured today. Information collected preferably includes the statistical distribution of the target metrics.

3. Identify the desired properties of product: In cases where the MANUFACTURER seeks to improve and/or modify the target metrics, the desired values and statistical distributions of the target metrics are identified.

4. Prioritize the desired properties of the product: The relative priority of the different target metrics is identified in case this information will be needed for future decisions when the procedure is developed.

5. Identify current control parameters, ranges and methods: The typical values used in manufacturing and the control methods are identified.

6. Identify the manufacturing processes a particular product will experience before and after the manufacturing process under consideration. In the situation where the manufacturing process under consideration is the last manufacturing process, some examples of processes identified after the manufacturing process include, but are not limited to, packaging and shipment processes.

7. Identify the other manufacturing processes that are typically performed on the same manufacturing equipment.

8. Identify the typical failures of the manufacturing processes that are typical to the same manufacturing equipment.

9. Identify the variability in the operating conditions around their prescribed values during the process of manufacturing.

10. Identify the number of and method of product tests in use to assure the target metrics are within the acceptable range for the properties of the manufactured product.

11. Identify the drift or change of the target metrics as the manufacturing process is repeated.

12. Identify the procedures and timing for when the manufacturing equipment is maintained (product maintenance=PM) and/or cleaned.

13. Set desired properties of the manufacturing process: In cases where the MANUFACTURER seeks to improve and/or modify the current manufacturing practice, he may modify any of the following properties, alone or in combination:

a. the typical values used for control parameters

b. the control methods

c. the manufacturing processes a particular product will experience before and after the manufacturing process under consideration

d. other manufacturing processes that are typically performed on the same manufacturing equipment

e. the maintenance and cleaning procedures and timing of maintenance or cleaning

f. the variability in the operating conditions around their prescribed values during the process of manufacturing

g. the number of and method of product tests now used to assure the target metrics are within the acceptable range for all the manufactured product, or

h. the drift and changes of the target metrics as the manufacturing process is repeated.

14. Prioritize the desired properties of the manufacturing process: The relative priorities of the different properties of the manufacturing process are identified in case this information is needed for future decisions when the procedure is developed.

15. Characterize current properties of materials involved in the product and the manufacturing process: The PROVIDER and/or the MANUFACTURER collect information that characterizes the properties of the materials of the products and the manufacturing processes as they are manufactured today. Information collected preferably includes the materials, the properties of the materials, the statistical distribution of the properties of the materials, the products and the manufacturing processes, and the quality assurance procedures of the materials.

16. Prescribe the desired properties of materials: In cases where the MANUFACTURER seeks to improve and/or modify the materials, the properties of the materials, the statistical distribution of the properties of the materials of the products and the manufacturing processes, and the quality and quality assurance procedures of the materials are defined.

17. Prioritize the desired properties of the materials: The relative priority of the different materials and their different properties is identified in case this information is needed for future decisions when the procedure is developed.

18. Determine current properties of the manufacturing machines involved in the product and the manufacturing process: The PROVIDER and/or the MANUFACTURER collect information that characterizes the properties of the manufacturing machines used in the production of the products as they are manufactured today. Information collected includes the structure, geometry, and other properties of the manufacturing machines.

19. Determine the desired properties of the manufacturing machines involved in the product and manufacturing process: This step is undertaken in situations where the MANUFACTURER seeks to improve and/or modify the manufacturing machines and/or the properties of the manufacturing machines involved in the manufacturing process and the quality of the product due to the properties of the manufacturing machines.

20. Prioritize the desired properties of the manufacturing machines: The relative priority of the manufacturing machines and their different properties is identified in case this information is needed for future decisions when the procedure is developed.

21. Characterize current measurements and metrology apparatus (metrology apprt) of the properties of the products and the manufacturing processes: The PROVIDER and/or the MANUFACTURER collect information that characterizes the properties of the current measurement and metrology apparatus, or measurement tools, measuring the properties of the products and the processes and procedures used in the production and quality assurance of the products and the processes as they are applied today on the products manufactured today. Information collected includes the measurement methods, the calibration procedures, apparatus failures, the statistical distribution of the measurements due solely to the measurement apparatus itself and the statistical distribution of the measurement due to human operation, operators' errors and any other errors in the procedures.

22. Determine the desired properties of the measurements and metrology apparatus of the properties of the products: This step is undertaken in situations where the MANUFACTURER seeks to improve and/or modify the current measurement and measurement tools and procedures used in the production and quality assurance of the products and the processes as they are applied today on the products manufactured today, the measurement methods, the calibration procedures, the apparatus failures and the statistical distribution of the measurements due solely to the measurement apparatus itself, and the statistical distribution of the measurements due to human operation, operators' errors and other errors in the procedures.

23. Prioritize the desired properties of the measurements and metrology apparatus of the properties of the products: The relative priority of the different properties is identified in case this information is needed for future decisions when the procedure is developed.

24. Define a protocol for qualification of the process, materials, manufacturing machines, and measurement apparatus to enable providing the guaranteed services which arise from the data gathered and prioritized in steps 1-23.

25. Identify the exceptions which limit the guaranteed services: Sort and identify all the elements and subjects included in the processes, the materials, the manufacturing machines and the measurements and measurement apparatus, which limit or make conditional the full guaranteed services.

26. Produce recommendations for upgrades: The recommendations, based on the identification of the gaps, are given to the MANUFACTURER.

27. Accept upgrades: The MANUFACTURER decides which upgrades he accepts. The upgrades which the MANUFACTURER does not accept are the QUALIFICATION GAPS.

28. Identify activity limitations due to the QUALIFICATION GAPS: The PROVIDER provides a list of servicing activities, which fit the existing and the upgraded qualification and the prioritization properties lists.

29. Prepare proposal: The PROVIDER prepares and submits the guaranteed servicing proposal including the list of activities, the guaranteed policy, the timings and the costs.

30. Sign agreement: the PROVIDER and the MANUFACTURER sign an agreement.

31. Experiments: Initial experiments of the manufacturing process are performed at the MANUFACTURER site and the measurement and measurement tools measure the properties of each product.

32. Adjust procedure: PROVIDER adjusts the PROCEDURE and the MANUFACTURER adjusts any tools used to carry out PROCEDURE.

33. Alpha Test: The MANUFACTURER performs alpha-experiments, and the provider adjusts the PROCEDURE accordingly.

34. Beta Test: The MANUFACTURER performs beta-experiments and the PROVIDER adjusts the PROCEDURE accordingly.

35. Charge: The PROVIDER starts charging for provided services. This step preferably occurs concurrently with step (100) shown in FIG. 1, when the provider provides the manufacturer with a procedure to use when setting up the manufacturing process.

### EXAMPLE

The invention can be applied to all industries and process in which a setup of equipment is needed in order to produce products with defined properties, which are measurable and have to be within defined acceptable ranges.

The following example is related to the semiconductor industry. Consider the manufacturing process of depositing a layer of material such as silicon oxide, copper or tungsten using the process known as Chemical Vapor Deposition (CVD), commonly undertaken in the manufacturing of integrated circuits in the semiconductor industry. The manufacturing machine used to perform this task, known as a CVD reactor, or reactor for short, is a complex manufacturing machine.

A business arrangement is created between the manufacturer (FAB) of a semiconductor integrated circuit that is interested in reducing his financial risk associated with fluctuating manufacturing costs resulting from fluctuations in the number of tests required to define the setup for a Chemical Vapor Deposition process (CVD) and a service provider (PROVIDER) that undertakes a set of commitments described below. The CVD has measurable process properties including deposition rate, which have to be within defined ranges.

CVD deposits a deposition layer of materials on a substrate called a wafer, with resultant measurable product properties. A “setup” of the manufacturing machine involves setting the values of a multitude of process parameters that determine the characteristics of the process to be undertaken and the quality of the resultant product. Examples of such process parameters include the flow rates of different gases entering the reaction chamber, the distance between the deposition substrate and the top wall of the chamber, the electrical intensity of the plasma generated in the reactor, the length of time allotted to the deposition process, and other such parameters, called the “control variables”.

In this example, wafer properties are used instead of the general properties and CVD properties are used instead of the general process properties. Properties include both wafer properties and CVD properties.

The quality of the resultant product is characterized by measures such as the thickness of the deposited layer, the internal stresses in the deposited layer, the electrical characteristics of the layer, the uniformity of the layer across the deposition substrate, and other such parameters, called the “target metrics”.

Depending on the product being manufactured, there are acceptable ranges for the target metrics. The process of setup is the process of determining the values of the control variables that will bring the target metrics into their acceptable range. In many manufacturing applications, of which CVD is a good example, the process of setup is one that requires multiple tests or trial-and-error attempts.

Tests are expensive. They consume materials and operator time, increase time to market, and represent a significant cost in the way of lost manufacturing time. The number of such tests varies from attempted setup to attempted setup. This variability introduces a business risk: the costs of manufacturing may fluctuate in a way that may have material financial impact on a company. In the case of semiconductor manufacturing, the costs of tests required for proper setup of equipment can be as high as 10% of the cost of the manufacturing costs of the finished product. In many cases the fluctuations in cost that result from fluctuations in the number of tests can be more than the profit margin on the product. So, by utilizing the method of the present invention, the manufacturer is protected from the fluctuations in testing costs.

In this example, the wafer is preferably made out of silicon and the deposition material is preferably silicon oxide. The product properties (the wafer after being subjected to the CVD process of silicon oxide) include thickness (TH) to be within +3% and −3% of TH (TH%=accepted range), non-uniformity to be within 2.5% (NonU%=accepted range) and stress (ST) to be within defined an upper limit (STU) and a lower limit (STL) (STU-STL=accepted range). Each of these properties are measured by measurement tools (metrology equipment). In addition, there are two process properties: the deposition rate (RD) to be within defined an upper limit (RDU) and a lower limit (RDL) (RDU-RDL=accepted range) and the TIME the process is performed to be within a defined upper limit (TIMEU) and lower limit (TIMEL) (TIMEU-TIMEL=accepted range).

The input gas materials of the reactor are preferably diluted TEOS and Ozone supplied in TEOS-FLRT and Ozone-FLRT, and the process is done at a high temperature (TEMP). TEOS-RT and Ozone-RT and the TEMP are the input setup of the reactor. RD=TH/TIME of performing the CVD process in the reactor.

Referring back to FIG. 1, in step (100), the PROVIDER provides to the FAB a PROCEDURE to use when setting up the CVD process in a reactor to deposit a layer of silicon oxide. The PROCEDURE suggests a set of setups (TEOS-FLRT, Ozone-FLRT and TEMP) to run a set of tests in the reactor in order to get the resultant wafer properties TH, NonU and ST of the wafer and the single CVD property RD and TIE to be within the accepted ranges RDU-RDL and TIMEU-TIMEL.

The PROVIDER is committed to providing a PROCEDURE to the FAB, which may include any of the following components, alone or in combination. The PROVIDER may provide software that suggests to the process engineer of the FAB what set of setup tests to perform based on inputs provided by the process engineer or the operator of the reactor to the software. The software may be provided as a standalone item or as software that interfaces with automatic manufacturing control and/or execution systems. The software may make use of a communications network to transmit the information to and from remote computers. The PROVIDER also may provide procedures for qualifying the manufacturing process, materials, reactor (manufacturing machine), and measurement (metrology) equipment. In addition, the PROVIDER may provide training to the personnel of the FAB, i.e. the process engineers and the operators. The training may include qualification of engineers and operators. The PROVIDER may also provide support and upgrades on an agreed upon basis. The PROVIDER also agrees to hold information provided by the FAB in confidence.

In step (110), the PROVIDER provides a GUARANTEE to the FAB that, if the FAB and his employees (engineers and operators) follows the PROCEDURE, the CVD process will require less than a prescribed number of tests to get the wafer properties and the CVD properties (target metrics) to be within the acceptable range (MAX TESTS).

The GUARANTEE may include any of the following components, alone or in combination. First, the PROVIDER may guarantee that after maintenance or clean up, the equipment (assuming there are no failures from the CVD reactor specifications) will get to an operational point in less than a prescribed number of tests. Also, the PROVIDER may guarantee that every time a test is performed as part of the routine procedure and the results of the test and desired goals are input to the PROCEDURE, the proposed setup will bring the resultant properties to the acceptable range. The GUARANTEE may also include that the setup resulting from the application of the PROCEDURE will have the lowest sensitivities as measured by a software tool provided by the PROVIDER. Sensitivities indicate the extent to which a metric that one wishes to control depends on a setup parameter. A “high” sensitivity indicates that relatively small changes in a setup parameter result in large changes in the metric, while a setup with a “low” sensitivity requires large changes in a setup parameter to change the metric. Sensitivities are preferably expressed as numbers, graphs or tables. The PROVIDER may also guarantee that, on average, the number of tests performed will be less than a prescribed amount.

In consideration of the PROCEDURE, the GUARANTEE, and the potential future PAY OUT, the FAB pays the PROVIDER an amount that may depend on the manufacturing process and reactor, wafer and material in step (120). The fee is preferably calculated by any of the following methods, alone or in combination: a fixed amount per year per piece of manufacturing equipment, a fixed amount per use of the PROCEDURE, a fixed sum per FAB , or charges for support of the FAB in the application of the PROCEDURE.

In step (130), the question whether the properties entered the acceptable ranges in MAX TESTS or less is asked. Every time the FAB follows the PROCEDURE and the properties do not enter the acceptable ranges in MAX TESTS, or less, experiments, the PROVIDER pays the FAB an agreed amount (PAY OUT) that can be fixed or variable in step (140). However, if the properties do enter the acceptable ranges in less than or equal to MAX TESTS, the PROVIDER is not required to pay the FAB anything.

The agreement includes a commitment by the PROVIDER to reimburse the FAB when the PROCEDURE provided by the PROVIDER does not enter the properties' acceptable ranges in MAX TESTS or less. This commitment may be subject to exclusions that include the following, alone or in combination. First, all the qualifications agreed upon between the PROVIDER and the FAB must have been performed. The FAB will notify the PROVIDER within a given period of time that the PROCEDURE did not produce the committed to results and will allow the PROVIDER a prescribed amount of time to improve the PROCEDURE. The FAB will not seek reimbursement from the PROVIDER for setups performed prior to the time the PROVIDER agrees to resumption of the use of the PROCEDURE.

The reimbursement to the FAB described above is preferably calculated by either of the following methods alone or in combination. First, reimbursement may be determined based on the down time of the CVD reactor. Alternatively, reimbursement is determined on a fixed price per failure of the PROCEDURE. In a third method, reimbursement is based on a modified price per each failure of the PROCEDURE as in an agreed upon formula.

Variations to the preferred embodiment preferably include, but are not limited to, guarantees concerning requirements for training of operators, proper performance of the equipment, qualification of various auxiliary equipment used to measure the target metrics and, as well as other variations.

Referring also back to FIG. 2a through 2c, to consummate the agreement between the MANUFACTURER and the PROVIDER, a method which includes the following steps, or any subset of them, is preferably undertaken:

1. The FAB identifies to the PROVIDER the manufacturing process for which it would like to have a guarantee. During this step, the CVD reactors on which the identified process is being performed are also preferably identified.

2. The PROVIDER and/or the FAB collect information that characterizes the current wafer properties. Information collected preferably includes the statistical distribution of the target metrics.

3. In cases where the FAB seeks to improve and/or modify the wafer properties, the desired values and statistical distributions of the properties are identified.

4. The relative priority of the different wafer properties is identified in case this information will be needed for future decisions when the procedure is developed.

5. TEOS-FLRT, Ozone-FLRT, TEMP ranges and methods and TIME range are identified.

6. The details of the manufacturing processes a wafer will experience before and after the CVD process under consideration are identified.

7. The other manufacturing processes that are typically performed on the same CVD reactor are identified.

8. The typical failures of the CVD process under consideration that are typical on the same CVD reactor are identified.

9. The variability in the operating conditions around their prescribed setup values during the CVD process is identified.

10. The number of and method of product tests (the measurement—metrology tests) in use are identified to assure that the wafer properties are within the acceptable range.

11. The drift or change of the wafer properties is identified as the CVD is repeated in the same reactor.

12. The procedures and timing for when the reactor is maintained (product maintenance=PM) and/or cleaned are identified.

13. In cases where the FAB seeks to improve and/or modify the current manufacturing practice, he may modify any of the following properties, alone or in combination:

a. the typical values used for setup and control parameters: TEOS-FLRT, Ozone-FLRT, TEMP and TIME

b. the control methods

c. the manufacturing processes a particular wafer will experience before and after the manufacturing process under consideration

d. other manufacturing processes that are typically performed on the same reactor

e. the maintenance and cleaning procedures and timing of maintenance or cleaning of the reactor

f. the variability in the operating conditions around their prescribed values during the CVD process

g. the number of and method of product tests now used to assure the target CVD properties and wafer properties are within the acceptable range for all the manufactured wafers, or

h. the drift and changes of the wafer properties as the CVD process is repeated in the same reactor.

14. The relative priorities of the different properties of the CVD process are identified (like RD first and TIME second) in case this information is needed for future decisions when the procedure is developed.

15. The PROVIDER and/or the FAB collect information that characterizes the properties of the input materials (TEOS, Ozone and wafer) of the products and the manufacturing processes as they are manufactured or purchased today. Information collected preferably includes the materials, the properties of the materials, the statistical distribution of the properties of the materials, the products and the manufacturing processes, and the quality assurance procedures of the materials, etc.

16. In cases where the FAB seeks to improve and/or modify the materials (TEOS, Ozone and wafer), the properties of the materials, the statistical distribution of the properties of the materials of the products and the manufacturing processes, and the quality and quality assurance procedures of the materials are defined.

17. The relative priority of the different materials and their different properties is identified in case this information is needed for future decisions when the procedure is developed.

18. Determine current properties of the reactors involved in the product and the manufacturing process like the showerhead (the gas spraying device, SHED). The PROVIDER and/or the FAB collect information that characterizes the properties of the reactors used in the production of the wafers as they are manufactured today. Information collected includes the structure, geometry, and other properties of the reactors.

19. The desired properties of the reactors involved in the product and manufacturing process are determined in situations where the FAB seeks to improve and/or modify the SHED and/or other properties of the reactors involved in the manufacturing process and the quality of the product due to the properties of the reactors.

20. The relative priority of the reactors and their different properties is identified in case this information is needed for future decisions when the procedure is developed.

21. The PROVIDER and/or the MANUFACTURER collect information that characterizes the properties of the current measurement and metrology apparatus, or measurement tools, measuring the wafer properties and the CVD processes and procedures used in the production and quality assurance of the resultant wafers and the processes as they are applied today on the wafers manufactured today. Information collected includes the measurement methods, the calibration procedures, apparatus failures, the statistical distribution of the measurements due solely to the measurement apparatus itself and the statistical distribution of the measurement due to human operation, operators' errors and any other errors in the procedures.

22. The desired properties of the measurements and metrology apparatus of the wafer properties are determined in situations where the FAB seeks to improve and/or modify the current measurement and measurement tools and procedures used in the production and quality assurance of the products and the processes as they are applied today on the products manufactured today, the measurement methods, the calibration procedures, the apparatus failures and the statistical distribution of the measurements due solely to the measurement apparatus itself, and the statistical distribution of the measurements due to human operation, operators' errors and other errors in the procedures.

23. The relative priority of the different wafer properties is identified in case this information is needed for future decisions when the procedure is developed.

24. A protocol for qualification of the CVD process, input materials, reactors, and measurement apparatus is defined to enable providing the guaranteed services which arise from the data gathered and prioritized in steps 1-23.

25. All the elements and subjects included in the processes, the materials, the manufacturing machines and the measurements and measurement apparatus, which limit or make conditional the full guaranteed services, are sorted and identified.

26. Upgrade recommendations, based on the identification of the gaps identified in step 25, are produced and given to the FAB.

27. The FAB decides which upgrades he accepts. Any upgrades which the FAB does not accept are the QUALIFICATION GAPS.

28. The PROVIDER provides a list of servicing activities, which fit the existing and the upgraded qualification and the prioritization properties lists.

29. The PROVIDER prepares and submits the guaranteed servicing proposal including the list of activities, the guaranteed policy, the timings and the costs.

30. The PROVIDER and the FAB sign an agreement.

31. Initial experiments of the manufacturing process are performed at the FAB and the measurement and measurement tools measure the properties of each product.

32. PROVIDER adjusts the PROCEDURE and the FAB adjusts any tools used to carry out PROCEDURE.

33. The FAB performs alpha-experiments, and the provider adjusts the PROCEDURE accordingly.

34. The FAB performs beta-experiments and the PROVIDER adjusts the PROCEDURE accordingly.

35. The PROVIDER starts charging for provided services. This step preferably occurs concurrently with step (100) shown in FIG. 1, when the provider provides the manufacturer with a procedure to use when setting up the manufacturing process.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A method for charging for and guaranteeing services provided to a manufacturer, executing a manufacturing process on manufacturing equipment, by a provider comprising the steps of:
a) the provider providing the manufacturer with:
i) a procedure to use when setting up a manufacturing process; and
ii) a guarantee, wherein said guarantee states that if the manufacturer follows said procedure, the manufacturing process will require less than a prescribed number of tests to get a plurality of target metrics of at least one product into an acceptable range; and
b) if the manufacturing process requires more than said prescribed number of tests, the provider paying the manufacturer a first monetary sum.

2. The method of claim 1, wherein said procedure in step (a) comprises the substep of the provider providing software that suggests to the manufacturer what tests to perform based on input into the software.

3. The method of claim 1, wherein said procedure in step (a) comprises the substep of the provider providing a plurality of procedures for qualifying at least one aspect of the manufacturing process, the aspect being selected from the group consisting of:
a) a plurality of materials;
b) at least one manufacturing machine; and
c) at least one piece of measurement equipment.

4. The method of claim 1, further comprising the step of the provider providing training to personnel of the manufacturer.

5. The method of claim 1, wherein the guarantee in step (a) (ii) further comprises at least one guarantee selected from the group consisting of:
a) a guarantee that at least one piece of equipment will get to an operational point in less than a prescribed number of tests after maintenance or clean up;
b) a guarantee that every time the procedure is applied and the results of the tests and desired goals are input to the procedure, a proposed setup will bring a plurality of performance metrics of a product to an acceptable range; and
c) a guarantee that a setup resulting from at least one application of the procedure will have the lowest sensitivities as measured by a software tool provided by the provider.

6. The method of claim 1, wherein said guarantee in step (a) (ii) is a guarantee that a number of tests performed will be less than a prescribed amount on average.

7. The method of claim 1, wherein, in step (b), the first monetary sum is calculated by at least one method selected from the group consisting of:
a) determining the first monetary sum based on a down time of the manufacturing process;
b) determining the second monetary sum based on a fixed price per each failure of the procedure; and
c) determining the first monetary sum based on a modified price per each failure of the procedure as in an agreed-upon formula.

8. The method of claim 1, further comprising the step of the manufacturer paying the provider a second monetary sum calculated by a method selected from the group consisting of:
a) determining a fixed amount per prescribed period of time per piece of manufacturing equipment;
b) determining a fixed amount per use of the procedure;
c) determining a fixed sum per manufacturing facility; and
d) determining a charge for support of the manufacturer in at least one application of the procedure.

9. The method of claim 1, further comprising, prior to step (a), the step of characterizing a plurality of current properties of the product.

10. The method of claim 9, in which the characterizing step comprises the substeps of:
identifying at least one desired property of the product; and
prioritizing the desired properties of the product.

11. The method of claim 9, further comprising the step of measuring the current properties of the product.

12. The method of claim 11, wherein the measuring step is accomplished using metrology tools.

13. The method of claim 1, further comprising, prior to step (a), the step of identifying at least one current control parameter.

14. The method of claim 1, further comprising, prior to step (a), the step of identifying at least one manufacturing process the product will experience before the manufacturing process under consideration.

15. The method of claim 1, further comprising, prior to step (a), the step of identifying at least one process the product will experience after the manufacturing process under consideration.

16. The method of claim 1, further comprising, prior to step (a), the step of identifying other manufacturing processes that are typically performed on the same manufacturing equipment.

17. The method of claim 1, further comprising, prior to step (a), the step of identifying at least one typical failure of the manufacturing processes that are performed on the same manufacturing equipment as the manufacturing process under consideration.

18. The method of claim 1, further comprising, prior to step (a), the step of identifying variability in a plurality of operating conditions around a plurality of prescribed values during the manufacturing process.

19. The method of claim 1, further comprising, prior to step (a), the step of identifying a number and a method of product tests in use to assure that the target metrics are within an acceptable range for the product.

20. The method of claim 1, further comprising, prior to step (a), the step of identifying any drift or change of the target metrics when the process is repeated.

21. The method of claim 1, further comprising, prior to step (a), the step of identifying a procedure for maintenance or cleaning of said product.

22. The method of claim 1, further comprising, prior to step (a), the step of setting at least one desired property of said manufacturing process, wherein said desired property is selected from the group consisting of:
a) at least one value used for at least one control parameter;
b) at least one control method;
c) at least one manufacturing process that the product undergoes before the manufacturing process under consideration;
d) at least one process that the product undergoes after the manufacturing process under consideration;
e) additional manufacturing processes that are typically performed on the same manufacturing equipment;
f) at least one maintenance or cleaning procedure;
g) timing of said maintenance or cleaning procedure;
h) variabilities in all operating conditions around a prescribed value during the manufacturing process;
i) numbers and methods of product tests currently used to assure that the target metrics are within an acceptable range for the product; and
j) any drift or change of the target metrics when the manufacturing process is repeated.

23. The method of claim 22, further comprising the step of prioritizing the desired properties of the manufacturing process.

24. The method of claim 1, further comprising, prior to step (a), the step of characterizing a plurality of current properties of a plurality of materials involved in manufacturing the product.

25. The method of claim 24, wherein the current properties are selected from the group consisting of:
a) the properties of the materials;
b) a statistical distribution of the properties of the materials; and
c) at least one quality assurance procedure of the materials.

26. The method of claim 24, wherein the step of characterizing comprises the substeps of:
identifying at least one desired property of the materials; and
prioritizing the desired properties of the materials.

27. The method of claim 1, further comprising, prior to step (a), the step of determining at least one current property of at least one manufacturing machine involved in the manufacturing process.

28. The method of claim 27, in which the step of determining comprises the substeps of:
identifying at least one desired property of the manufacturing machine; and
prioritizing the desired properties of the manufacturing machine.

29. The method of claim 1, further comprising, prior to step (a), the step of characterizing at least one current measurement using at least one metrology tool for the manufacturing process.

30. The method of claim 29, wherein a property of the current measurement is selected from the group consisting of:
a) at least one measurement method and apparatus;
b) at least one calibration procedure of the apparatus;
c) a statistical distribution of the measurements due solely to the measurement apparatus;
d) a statistical distribution of the measurement due to human operation; and
e) a statistical distribution of the measurement due to operator error.

31. The method of claim 29, wherein the characterizing step comprises the substeps of:
identifying at least one desired property of the measurement; and
prioritizing the desired properties of the measurement.

32. The method of claim 1, wherein step (a) (ii) comprises the substep of identifying any exceptions which limit the guarantee.

33. The method of claim 1, wherein, when there is at least one qualification gap in the guarantee, step (a) (ii) comprises the substep of recommending at least one upgrade to the manufacturer, wherein said provider recommends said upgrade to cover said corresponding qualification gap in the guarantee.

34. The method of claim 33, further comprising the substep of accepting or rejecting said upgrade, wherein said manufacturer accepts or rejects said upgrade, and any upgrade which is rejected is a qualification gap which is not covered by the guarantee.

35. The method of claim 1, further comprising the step of conducting experiments on the manufacturing process.

36. The method of claim 35, further comprising the step of adjusting the procedure based on the experiments.
